(19) United States
(12) Patent Application Publication
(10) Pub. No.: US 2026/0307087 A1
(43) Pub. Date: Oct. 8, 2026

(54) Modular Low-Pressure Misting Apparatus for Chemical Dispersion

(71) Applicant: Justin Lawrence Huckabee, Miramar, FL (US)

(72) Inventor: Justin Lawrence Huckabee, Miramar, FL (US)

(73) Assignee: Justin Lawrence Huckabee, Miramar, FL (US)

(21) Appl. No.: 19/169,115

(22) Filed: Apr. 3, 2025

(51) Int. Cl. B05B 7/32; B05B 1/02; B05B 12/02; B05B 15/40

(52) U.S. Cl. CPC B05B 7/32; B05B 1/02; B05B 12/02; B05B 15/40

(57) ABSTRACT

A fluid distribution apparatus is provided for delivering a diluted chemical solution through a network of spray nozzles using pressurized water. The apparatus includes an inlet for connection to a water source, a filtration unit to remove particulates, a pressure regulation unit to stabilize water pressure, and a chemical mixing unit comprising a chemical reservoir and a mixing interface for introducing concentrate into the water stream. A timing control mechanism is configured to permit or restrict water flow based on a predetermined schedule. The apparatus further includes a fluid conduit network and a plurality of spray nozzles connected thereto for emitting the diluted solution in atomized form. All components are arranged in fluid communication and are configured for operation without electrical power or active pumping.

### FIELD OF INVENTION

The present invention relates to fluid delivery systems, and more particularly to misting apparatuses configured for distributing diluted chemical solutions through spray nozzles utilizing passive water pressure.

### BACKGROUND

Insect control systems for residential and commercial outdoor environments have become increasingly prevalent, particularly in regions where mosquito populations present a persistent public health or nuisance concern. Among the most commonly deployed technologies are automated misting systems that disperse insecticidal solutions over a predefined area using networks of spray nozzles. These systems often provide consistent and repeatable coverage with minimal user intervention. However, existing solutions frequently entail complex setups, significant upfront installation costs, and ongoing maintenance requirements, which limit their accessibility and appeal for many consumers.

A predominant limitation in many currently available misting systems is their dependence on electrically powered components. Most commercial-grade installations incorporate high-pressure electric pumps, digital controllers, solenoid valves, and agitation devices to deliver and manage the chemical misting process. These components typically require proximity to a dedicated power source, often necessitating the installation of a new 120V electrical outlet, frequently by a licensed electrician. This not only increases the installation cost and complexity but also limits the flexibility of system placement, particularly in properties lacking convenient access to power near the treatment area.

Additionally, many existing systems rely on large-capacity reservoirs—commonly in the range of 55 gallons or more—to store a pre-mixed solution of water and insecticide. These reservoirs consume substantial physical space, may require protective housing, and must be periodically refilled with a balanced chemical mix. Improper mixing or chemical separation over time may result in inconsistent misting efficacy. Furthermore, the need for motor-driven agitation to maintain solution homogeneity introduces additional points of failure and ongoing maintenance obligations. The pumps and valves used in high-pressure systems also entail higher replacement costs and are more prone to mechanical degradation due to their reliance on moving parts operating under pressure.

From a cost perspective, these traditional systems impose significant barriers for average residential users. Installation of even a basic setup comprising approximately 20 nozzles can cost in excess of $2,500 to $3,000, with monthly servicing fees ranging from $150 to $180. These recurring costs place such systems firmly in the realm of high-end or luxury landscaping solutions, and thus are often underutilized in mainstream residential markets. Moreover, the complexity of component replacement and system diagnosis discourages DIY maintenance, leading to further reliance on third-party service providers.

A review of prior art, such as the mosquito misting system disclosed in U.S. Pat. No. 7,090,147B2, reveals many of these inherent drawbacks. This reference describes a system using a motorized pump, a large-capacity reservoir, and a digital control interface to automate insecticide dispersal. While functionally capable, the system necessitates electrical power and includes numerous components such as level sensors, pressure switches, and an agitator assembly—all of which add complexity, cost, and multiple potential failure points. The system's dependence on centralized, power-reliant infrastructure and its sizable physical footprint make it less suitable for users seeking portability, ease of installation, or low-cost operation. Notably, it does not contemplate operation driven solely by water pressure or the use of lightweight, modular components compatible with existing household infrastructure.

The cumulative effect of these limitations has contributed to a demand for more accessible and user-friendly alternatives. Homeowners, in particular, are seeking systems that can be installed without professional assistance, powered without electricity, and serviced at minimal cost. There exists a need for misting systems that are compact, modular, and adaptable to various outdoor configurations, while still delivering effective insect control performance. Such systems must not only function reliably but also reduce dependency on proprietary parts, extensive wiring, and costly service contracts. These factors have collectively underscored the importance of rethinking how insect misting systems are constructed, operated, and maintained.

It is within this context that the present invention is provided.

### SUMMARY

The present invention relates to a fluid distribution apparatus for dispersing a diluted chemical solution through a network of spray nozzles, the apparatus being configured to operate using only household water pressure. The system comprises a sequence of components arranged in fluid communication, including an inlet adapted for connection to a pressurized water source, a filtration unit for removing particulates or impurities, a pressure regulation unit to stabilize flow pressure, a chemical mixing unit with a reservoir and mixing interface, a timing control mechanism to control water flow, a fluid conduit network, and a plurality of spray nozzles for atomizing the fluid.

The system functions without electrical power or active pumping mechanisms, thereby simplifying installation and operation. All components are selected or configured for compatibility with standard garden infrastructure. The system supports assembly using commercially available hardware and permits routine maintenance or reconfiguration without specialized tools.

In some embodiments, the filtration unit comprises an inline replaceable filter cartridge capable of removing particulates, chlorine, or other waterborne contaminants. This helps prevent clogging of the nozzles and protects the internal components of the system.

In some embodiments, the pressure regulation unit comprises a mechanical regulator that reduces incoming water pressure to a controlled range between approximately 10 psi and 30 psi. This ensures consistent misting performance and prevents over-pressurization of the conduit network.

In some embodiments, the chemical reservoir of the chemical mixing unit comprises a removable container with a fluid capacity between 250 milliliters and 2000 milliliters. This enables the user to refill or replace the concentrate without disassembling the system.

In further embodiments, the mixing interface comprises a venturi injector, allowing the chemical concentrate to be introduced into the flowing water stream through a suction mechanism. This provides consistent dilution ratios without requiring active mixing or pressurization of the concentrate.

In some embodiments, the timing control mechanism comprises a mechanical timer configured to actuate a valve at programmable intervals. This allows for operation without batteries or electronic control.

In other embodiments, the timing control mechanism comprises a programmable, battery-operated hose timer. This provides additional flexibility and scheduling precision while maintaining ease of use.

In some embodiments, the fluid conduit network comprises flexible polymeric tubing with diameters between ⅛ inch and ⅜ inch. This facilitates routing through various outdoor environments and simplifies installation.

In some embodiments, the spray nozzles are atomizing nozzles with internal orifices sized to emit mist at pressures below 30 psi. This permits the system to function effectively using low water pressure while maintaining a fine spray pattern.

In further embodiments, at least one of the spray nozzles includes a swivel head to allow for manual directional adjustment. This allows the spray pattern to be targeted more precisely to specific areas.

In some embodiments, the spray nozzles are spaced at intervals between approximately 2 feet and 6 feet along the conduit network. This allows the user to balance coverage area with fluid consumption.

In some embodiments, the spray nozzles comprise non-valved, single-orifice bodies without moving internal components. This simplifies manufacturing and reduces maintenance requirements.

In some embodiments, the components of the system are joined using threaded garden hose fittings. This enables tool-free assembly and disassembly using commonly available connectors.

In further embodiments, the components are connected using quick-disconnect hose fittings. This allows for rapid setup and teardown of the system.

In some embodiments, the conduit network includes a main conduit with a plurality of branch lines extending to individual nozzles. This enables the system to reach multiple areas from a single water source.

In some embodiments, the chemical mixing unit includes a bypass valve allowing the user to operate the system in water-only mode. This can be used for flushing or for non-chemical applications.

In some embodiments, the system includes mounting clips or stakes for securing the conduit network to fixed structures or the ground. This helps maintain nozzle orientation and tubing layout.

In some embodiments, a backflow prevention device is included upstream of the chemical mixing unit. This prevents reverse flow of treated water into the water supply.

In some embodiments, the inlet comprises a threaded connector compatible with a standard outdoor hose bib. This ensures the apparatus can be connected directly to typical residential water infrastructure.

In yet further embodiments, the filtration unit, pressure regulator, chemical mixing unit, and timing control mechanism are configured for linear inline installation along a common axis. This promotes a compact layout and simplifies system integration.

### BRIEF DESCRIPTION OF THE DRAWINGS

Various embodiments of the invention are disclosed in the following detailed description and accompanying drawings.

FIG. 1 illustrates an example fluid distribution system comprising a water source, filtration unit, pressure regulator, chemical mixer, and sprayer system arranged in series.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “inlet” refers to any component or fitting configured to receive water from a pressurized source. This includes, but is not limited to, hose connectors, threaded garden hose adapters, quick-connect couplings, or integrated spigot interfaces. In one example implementation, the inlet may be a standard ¾-inch GHT (garden hose thread) connector configured to attach directly to a residential outdoor water tap.

The term “filtration unit” refers to any component or combination of components capable of removing particulate matter, chlorine, sediment, or other impurities from water. This may include cartridge filters, granular activated carbon filters, mesh screens, or multi-stage filtering assemblies. In one example implementation, the filtration unit may comprise an inline hose filter rated to remove particles down to 50 microns and designed for replacement every 3 to 6 months, depending on water quality.

The term “pressure regulation unit” refers to any mechanical device or assembly configured to reduce and maintain water pressure at a desired operating level. This may include diaphragm regulators, spring-loaded valves, or flow-restricting orifices. In one example implementation, the pressure regulation unit may be a brass-bodied mechanical regulator factory-set to reduce household water pressure from 60 psi to approximately 20 psi.

The term “chemical mixing unit” refers to any apparatus for introducing a chemical concentrate into a water stream to create a diluted solution. This includes, but is not limited to, venturi-type injectors, bypass-style fertilizer mixers, and siphon-based dilution systems. In one example implementation, the chemical mixing unit may comprise a plastic-bodied venturi injector with a downstream check valve and a reservoir of insecticidal concentrate such as permethrin diluted at a 1:100 ratio.

The term “chemical reservoir” refers to any container, chamber, or refillable vessel configured to hold a concentrated liquid for mixing with a flowing water stream. This may include rigid or flexible containers constructed from plastic, glass, or chemical-resistant polymers. In one example implementation, the chemical reservoir may be a 1000 mL HDPE bottle fitted with a suction line for venturi-based chemical draw.

The term “timing control mechanism” refers to any component or system capable of selectively permitting or restricting water flow based on time-dependent settings or triggers. This includes mechanical timers, battery-operated electronic valves, and programmable irrigation controllers. In one example implementation, the timing control mechanism may be a battery-powered hose timer that opens a solenoid valve for 2 minutes twice daily at pre-set intervals.

The term “fluid conduit network” refers to any arrangement of tubing, hoses, pipes, or similar structures configured to transport liquid from one point to another. This includes both linear and branching arrangements formed from materials such as polyethylene, nylon, or PVC. In one example implementation, the conduit network may consist of ¼-inch polyethylene tubing arranged in a loop configuration with T-fittings at nozzle intervals.

The term “spray nozzle” refers to any device configured to emit liquid in a fine mist or atomized spray. This includes fixed or adjustable nozzles with internal orifices, fan spray tips, or cone-pattern emitters. In one example implementation, each spray nozzle may consist of a stainless steel misting tip with a 0.012-inch orifice, threaded into a plastic holder attached to the conduit network.

The term “venturi injector” refers to a fluidic device that uses the velocity of a moving fluid to create a low-pressure zone that draws another fluid into the stream. In one example implementation, a venturi injector may comprise a narrowed constriction in a hose assembly with a side port connected to a chemical reservoir, such that water flowing through the constriction induces suction and chemical uptake.

The term “non-electric” refers to any component or operation that does not require electrical energy for function. This includes devices powered solely by fluid pressure, mechanical actuation, or gravity. In one example implementation, a fully non-electric configuration may include a mechanical timer, venturi injector, and gravity-fed chemical reservoir, with no electrical circuits, batteries, or motors present anywhere in the system.

Throughout this disclosure, references to specific materials, thread types, or pressure ratings are provided for illustrative purposes only and should not be construed as limiting. Equivalent substitutions, known to those of ordinary skill in the art, may be used without departing from the scope of the invention.

### DESCRIPTION OF DRAWINGS

The following description sets forth exemplary embodiments of a fluid distribution apparatus configured to deliver a diluted chemical solution through a network of spray nozzles using only pressurized water. The apparatus is designed for simplicity, modularity, and cost-efficiency, and is particularly suited for residential or small-scale outdoor environments where conventional misting systems may be impractical due to installation complexity, high cost, or the need for electrical power.

Existing misting systems typically rely on electrically powered pumps, digital controllers, and large chemical reservoirs, requiring professional installation and ongoing maintenance. These systems often include components such as solenoid valves, agitation mechanisms, and sensor arrays that increase system complexity, cost, and susceptibility to failure. Moreover, the reliance on electrical infrastructure and high-pressure hardware limits flexibility and presents additional barriers for users without convenient access to power near the treatment area.

The present apparatus addresses these limitations by providing a low-pressure misting system that is fully operable without electricity or active pumping. The components are arranged in a sequential, in-line configuration and utilize commercially available garden-compatible hardware, including mechanical timers, pressure regulators, and venturi-style chemical injectors. The system connects directly to a standard household water source, such as an outdoor hose bib, and relies solely on water pressure to draw and dilute chemical concentrate, deliver fluid to multiple spray nozzles, and emit atomized mist.

The apparatus may be assembled, expanded, or serviced without specialized tools, and does not require any electrical wiring or programming beyond the basic scheduling of the timer mechanism. By eliminating the need for powered pumps, large premix reservoirs, and proprietary hardware, the invention offers a more accessible and versatile alternative to traditional misting systems while maintaining reliable distribution of chemical treatments such as insecticides.

In the embodiments described herein, numerous variations in materials, dimensions, component arrangements, and fluid handling strategies are contemplated. The invention is not limited to a specific form of chemical agent, conduit layout, or nozzle design, and may be implemented using various alternative components that achieve the same general result through passive fluidic control. Further details of the system architecture and example configurations are set forth below.

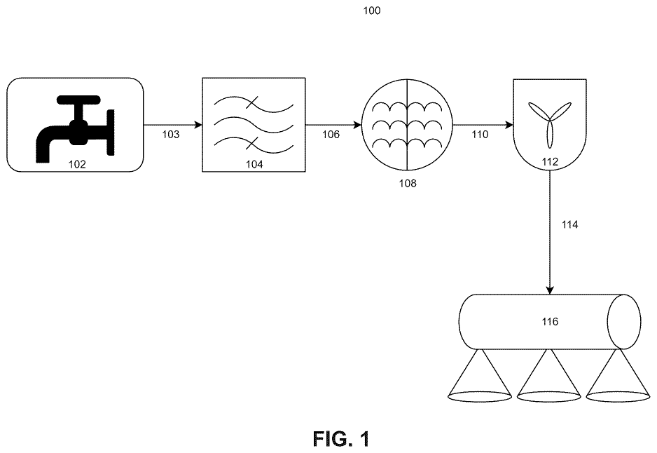

Referring now to FIG. 1, a schematic representation of a fluid distribution system 100 is shown. The system 100 is configured to deliver a diluted chemical solution to a sprayer system using household water pressure, without the need for electrical power or active pumping. The system is depicted as a series of components arranged in a linear, inline configuration, although alternative layouts such as branched or looped configurations are also contemplated.

The system 100 includes a water spigot 102, which serves as the inlet for a pressurized water supply. The water spigot 102 may be a conventional outdoor hose bib, typically threaded with standard ¾-inch garden hose threads (GHT), although other inlet types such as quick-connect hose adapters or threaded pipe fittings may be used. The spigot 102 is fluidly connected by a pipe or hose section 103 to a filter 104, which may take various physical forms. The filter 104 may be an inline replaceable cartridge filter, mesh screen, or multi-stage garden hose filter capable of removing particulates, chlorine, sediment, or other impurities from the water supply. Suitable filters may include granular activated carbon (GAC) media, sediment filters rated down to 50 microns, or combinations thereof, and may be housed in a rigid polymer or metal casing.

Downstream of the filter 104, a second connection 106 leads to a pressure regulator 108. The pressure regulator 108 may include spring-loaded, diaphragm-based, or flow-restricting mechanical devices. The regulator 108 is configured to reduce and stabilize water pressure to a lower operational range, such as between approximately 10 psi and 30 psi, which is suitable for low-pressure misting nozzles. In some embodiments, the pressure regulator may be integrated into a hose fitting or supplied as a standalone inline device with either male/female GHT connectors or compression fittings.

The outlet of the pressure regulator 108 is connected via a pipe or hose 110 to a mixer 112. The mixer 112 represents a chemical mixing unit configured to introduce a chemical concentrate into the water stream. In various implementations, the mixer 112 may comprise a venturi injector, a bypass fertilizer mixer valve, or other passive dilution device. A chemical reservoir (not shown in FIG. 1) may be coupled to the mixer 112 via a suction or siphon line, enabling the uptake of concentrated fluid such as an insecticidal formulation. In one example, the mixer may include a manually refillable reservoir with a capacity of 500 mL to 2 L, and a side-draw venturi section configured to dilute concentrate at ratios such as 1:100 or 1:128, depending on flow rate and nozzle demands.

A connection 114 leads from the outlet of the mixer 112 to a sprayer system 116, depicted as a terminal nozzle element in the schematic but representing a broader distribution network. The sprayer system 116 may include a main conduit and multiple branch lines composed of flexible tubing, such as polyethylene or nylon, with inner diameters ranging from ½ inch to ⅜ inch. A plurality of low-pressure spray nozzles may be affixed at regular intervals along the tubing, mounted via compression fittings, saddle tees, or barbed connectors. The nozzles may be constructed from plastic, brass, or stainless steel, and include fixed or adjustable atomizing tips with orifice sizes selected to operate effectively at pressures below 30 psi. In some embodiments, the nozzles may include swivel bases to allow for directional adjustment or may be installed in fixed orientations using stakes, clips, or brackets.

The components shown in FIG. 1 are arranged for clarity in a linear sequence, but the invention is not limited to this configuration. The filter 104, regulator 108, and mixer 112 may be integrated into a compact housing or supplied as separate modules. Each connection 103, 106, 110, and 114 may be implemented using threaded hose fittings, quick-disconnect couplings, or other releasable connectors. In certain embodiments, a timing control mechanism such as a mechanical or battery-powered hose timer may be installed upstream of the filter 104 or between the filter and regulator to control water flow based on a schedule. A backflow prevention valve may also be incorporated upstream of the mixer 112 to prevent contamination of the potable water supply.

While only one sprayer system 116 is schematically shown, the apparatus may include a larger distribution network with 10, 20, or more spray nozzles arranged throughout a treatment area such as a garden, patio, or lawn perimeter. The system may be installed as a temporary or permanent fixture, and is suitable for use with water-soluble chemical agents including insecticides, herbicides, or foliar nutrients. Variations in material, geometry, flow control, and mounting are within the scope of the invention as defined by the appended claims.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the fluid distribution apparatus of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A fluid distribution apparatus comprising:
(a) an inlet configured to be coupled to a pressurized water source;
(b) a filtration unit fluidly connected to the inlet and configured to remove particulates or impurities from water passing therethrough;
(c) a pressure regulation unit downstream of the filtration unit and configured to reduce and stabilize water pressure;
(d) a chemical mixing unit fluidly connected downstream of the pressure regulation unit, the chemical mixing unit comprising:
(i) a chemical reservoir; and
(ii) a mixing interface configured to introduce a chemical concentrate from the chemical reservoir into a water stream flowing through the chemical mixing unit;
(e) a timing control mechanism operatively connected between the inlet and the chemical mixing unit or located upstream thereof, the timing control mechanism being configured to selectively permit or restrict water flow based on a predetermined schedule;
(f) a fluid conduit network downstream of the chemical mixing unit and configured to convey a diluted solution; and
(g) a plurality of spray nozzles fluidly connected to the fluid conduit network and configured to emit the diluted solution in atomized form,
wherein the filtration unit, pressure regulation unit, chemical mixing unit, timing control mechanism, fluid conduit network, and spray nozzles are fluidly connected in series between the inlet and terminal ends of the apparatus.

2. The apparatus of claim 1, wherein the filtration unit comprises an inline replaceable filter cartridge configured to remove particulates, chlorine, or other waterborne contaminants.

3. The apparatus of claim 1, wherein the pressure regulation unit comprises a mechanical pressure regulator configured to reduce water pressure to a range between approximately 10 psi and 30 psi.

4. The apparatus of claim 1, wherein the chemical reservoir of the chemical mixing unit comprises a removable container having a fluid capacity between approximately 250 milliliters and 2000 milliliters.

5. The apparatus of claim 1, wherein the mixing interface of the chemical mixing unit comprises a venturi injector configured to introduce the chemical concentrate into the water stream using a suction effect.

6. The apparatus of claim 1, wherein the timing control mechanism comprises a mechanical timer configured to actuate a valve at predetermined intervals.

7. The apparatus of claim 1, wherein the timing control mechanism comprises a programmable battery-operated hose timer.

8. The apparatus of claim 1, wherein the fluid conduit network comprises a plurality of flexible polymeric tubes having diameters between approximately ⅛ inch and ⅜ inch.

9. The apparatus of claim 1, wherein at least one of the spray nozzles comprises an atomizing nozzle having an internal orifice sized to emit mist at pressures below 30 psi.

10. The apparatus of claim 1, wherein at least one of the spray nozzles comprises a swivel head mounted to allow directional adjustment of the spray pattern.

11. The apparatus of claim 1, wherein the spray nozzles are mounted at intervals along the fluid conduit network at a spacing between approximately 2 feet and 6 feet.

12. The apparatus of claim 1, wherein at least one of the spray nozzles comprises a non-valved, single-orifice body having no internal moving parts.

13. The apparatus of claim 1, wherein the components are coupled by threaded garden hose fittings.

14. The apparatus of claim 1, wherein the components are coupled by quick-disconnect hose fittings.

15. The apparatus of claim 1, wherein the fluid conduit network comprises a main conduit and a plurality of branch conduits leading to individual spray nozzles.

16. The apparatus of claim 1, wherein the chemical mixing unit further comprises a bypass valve configured to permit operation in a water-only mode by diverting flow around the chemical reservoir.

17. The apparatus of claim 1, further comprising a set of mounting clips or stakes configured to retain the fluid conduit network in a fixed position relative to a mounting surface.

18. The apparatus of claim 1, further comprising a backflow prevention device located upstream of the chemical mixing unit.

19. The apparatus of claim 1, wherein the inlet comprises a threaded connector compatible with a standard outdoor water spigot.

20. The apparatus of claim 1, wherein the filtration unit, pressure regulation unit, chemical mixing unit, and timing control mechanism are configured to be installed in a linear, inline arrangement along a common axis.
